(19) United States
(12) Patent Application Publication
(10) Pub. No.: US 2023/0291343 A1
(43) Pub. Date: Sep. 14, 2023

(54) DEMOLITION ROBOT WITH CONTROLLABLE CURRENT CONSUMPTION

(71) Applicant: HUSQVARNA AB, Huskvarna (SE)

(72) Inventors: Masoud Varshosaz, Sävedalen (SE); Victor Hofmeijer, Lerum (SE)

(21) Appl. No.: 18/119,375

(22) Filed: Mar. 9, 2023

(30) Foreign Application Priority Data
Mar. 10, 2022 (SE) 2250315-5

(51) Int. Cl. H02P 23/00; B60L 15/20; E02F 9/20

(52) U.S. Cl. CPC H02P 23/00; B60L 15/20; E02F 9/207; B60L 2240/421; B60L 2240/429; B60L 2210/20; B60L 2240/12; B60L 2240/423; B60L 9/00

(57) ABSTRACT

A motor drive system (300) for controlling an operation of an electric machine (330) on construction equipment (100), the system comprising a frequency converter (320) and a control unit (340),
where the frequency converter (320) is arranged to receive electrical power from electrical mains (310) over a first electrical interface (160) at a first AC frequency and to convert the first AC frequency into a second AC frequency for output on a second electrical interface (326) to the electric machine (330),
where the control unit (340) is arranged to control (360) the frequency converter (320) to generate the second AC frequency in dependence of a configurable maximum current to be drawn over the first electrical interface (160).

### TECHNICAL FIELD

The present disclosure relates to construction machines such as remotely controlled demolition robots and the like. There are disclosed motor drive systems and other related devices arranged to limit a current drawn from electrical mains during operation of an electrical motor. There are also disclosed systems comprising electrically configurable fuses and systems for monitoring current drawn over an interface to electrical mains in connection to a detected power loss.

### BACKGROUND

Construction machines such as light demolition robots are generally powered by combustion engines or from electrical mains via cable. In case of powering via cable, the current requirement is often quite high, e.g., 32 Amperes or higher, which may exceed the power rating of the electrical mains at some construction sites. Additional pieces of construction equipment may also operate on the same fuse, and the power rating of electrical mains may not be known, which complicates operation of some construction equipment.

Recently, hybrid electric demolition robots have been proposed, e.g., in EP2842213 A1. This machine comprises an auxiliary energy source, such as a battery, which allows for a temporary power outtake above the capability of the main power source. Thus, if the electrical mains is rated at, say 10 A, the combination of battery and electrical mains may together supply higher currents for a limited duration of time.

Battery capacity for powering construction machines is, however, limited, and not all construction machines are equipped with the type of hybrid systems discussed in EP2842213 A1. Thus, there is a continuing need for alternative solutions which enable operation of a construction machine such as a demolition robot when the electrical mains fuse is below the requirement for full power operation.

SE536147 C2 describes an electric demolition robot with a power limiting mode of operation where the hydraulic system is adjusted to operate at a reduced power consumption.

### SUMMARY

It is an object of the present disclosure to provide construction equipment such as demolition robots having a controllable maximum power consumption, allowing the equipment to operate at a construction site even if the power rating of the electrical mains at the construction site is below the nominal power requirements of the equipment.

This object is obtained by a motor drive system for controlling an operation of an electric machine on construction equipment. The system comprises a frequency converter and a control unit, where the frequency converter is arranged to draw electrical power from electrical mains over a first electrical interface at a first alternating current (AC) frequency and to convert the first AC frequency into a second AC frequency for output on a second electrical interface to the electric machine. The control unit is arranged to control the frequency converter to generate the second AC frequency in dependence of a configurable maximum current to be drawn over the first electrical interface. This way a maximum allowable current and/or power consumption of the motor drive system can be configured, and the motor drive system will then not draw more than the allowed amount of current. This means that the system can be configured to operate also at sites where electrical mains fusing is below the nominal power requirement of the construction equipment.

According to aspects, the control unit is arranged to control the output on the second electrical interface based on a target electric machine axle torque and/or based on a target electric machine axle speed determined in dependence of the configurable maximum current to be drawn over the first electrical interface. This way a predetermined relationship between electric machine axle torque and/or electric machine axle speed can be used to ensure that the current drawn over the first electrical interface does not exceed the configured maximum current to be drawn over the first electrical interface.

The control unit may also obtain a measurement of current drawn over the first electrical interface and control the output on the second electrical interface based on the measurement of current and on the configurable maximum current to be drawn over the first electrical interface. An advantage of using current measurements in this manner is that no predetermined relationship between motor control and drawn power is needed, since the actual current is fed back to the control unit which performs the motor control.

The control unit may also be arranged to predict a future current drawn over the first electrical interface based on a time sequence of obtained measurements of current drawn over the first electrical interface, and to control the output on the second electrical interface based on the predicted future current drawn over the first electrical interface. This allows the control unit to take action with reduced latency, since a future current is evaluated and can be used as base for the drive system control before the actual current drawn over the first electrical interface reaches levels close to the configurable maximum current to be drawn over the first electrical interface. Problems with over-shoot and the like can be mitigated in this manner.

According to aspects, the control unit is arranged to limit an acceleration of the electric machine in dependence of the configurable maximum current to be drawn over the first electrical interface. Current consumption during transient acceleration phases of an electric machine may be associated with unpredictable behavior in terms of current consumption. However, by limiting the acceleration allowed in the system, these transient effects can be controlled.

The maximum current to be drawn over the first electrical interface is according to an example arranged to be set by a user control input device, i.e., manually configured by an operator having knowledge about the maximum currents that can be drawn from electrical mains at a given site. However, the maximum current which is allowed to be drawn over the first electrical interface by the system may also be set in response to detection of a power loss on the first electrical interface, based on the current drawn over the first electrical interface at the time of the power loss, or on a statistical function of currents drawn at more than one power loss event. This means that the system remembers which current that was drawn when the fuse was triggered and records the current value in memory. The current value is then indicative of the maximum allowable current to be drawn. Statistical measures of the current drawn just prior to the power loss can also be used, which then also accounts for variation in the load on electrical mains at a given site.

The motor drive system also advantageously comprises an electrically configurable fuse arranged in between a power input port to the frequency converter and the first electrical interface. This electrically configurable fuse protects the fuse on electrical mains, and it is often more easily reset compared to the fuser on electrical mains, which may be hard to access. The electrically configurable fuse can be configured to disconnect the power input port to the frequency converter from the first electrical interface in response to a current drawn over the first electrical interface exceeding the configurable maximum current to be drawn over the first electrical interface.

The motor drive system optionally comprises an electrical energy storage device connected to a direct current (DC) bus of the frequency converter via a switch. The control unit may then control the switch in dependence of the current drawn over the first electrical interface and the configurable maximum current to be drawn over the first electrical interface. The electrical energy storage then cuts any transient power peaks drawn by the system, which reduces the risk of tripping a fuse on electrical mains.

The frequency converter may furthermore be arranged to control an amplitude of currents, i.e., voltage, output on the second electrical interface to the electric machine. The control unit can then be arranged to control the frequency converter to generate the amplitude in dependence of the configurable maximum current to be drawn over the first electrical interface, which is an advantage.

According to some aspects the frequency converter comprises a power factor correction circuit. This power factor correction circuit significantly reduces problems associated with reactive currents drawn via the first electrical interface, which is an advantage.

There is also disclosed herein a motor drive system for controlling an operation of an electric machine on construction equipment which comprises a first electrical interface arranged to be connected to electrical mains and a second electrical interface arranged to be connected at least indirectly to the electric machine. The drive system further comprises an electrically configurable fuse arranged in between the first electrical interface and the second electrical interface, where the electrically configurable fuse is configured to disconnect the first electrical interface from the second electrical interface in response to a current drawn over the first electrical interface exceeding a configurable maximum current of the electrically configurable fuse. This electrically configurable fuse protects the fuse and the other power electronics of the electrical mains at the work site, and it is often more easily reset compared to the electrical mains fuse, which may be hard to access and/or to replace. Some older electrical mains fuses may, e.g., be of melting type and replacement fuses may not be readily available. The electrical mains fuse may also be located behind a locked door or the like.

The electrically configurable fuse may be used with advantage independently of the frequency converters and the control units arranged to record current magnitude in connection to power loss discussed herein. However, the electrically configurable fuse can advantageously be configured to disconnect the power input port to the frequency converter discussed above from the first electrical interface in response to a current drawn over the first electrical interface exceeding the configurable maximum current to be drawn over the first electrical interface. The electrically configurable fuse may, e.g., be configured in dependence of a power rating or fuse configuration of electrical mains available at a given work site, thus preventing that the construction equipment trips the fuse or overloads the electrical mains at the work site. This way the electrical mains fuse is protected even if the electric machine powered by the frequency converter transiently draws an unexpectedly high power.

The maximum current setting of the electrically configurable fuse may be adjusted manually by an operator or automatically in dependence of a current measurement made in connection to a power outage event at a work site. The maximum current setting of the electrically configurable fuse is according to an example arranged to be set by a user control input device, i.e., manually configured by an operator having knowledge about the maximum currents that can be drawn from electrical mains at a given site. According to another example, the maximum current setting of the electrically configurable fuse is set in response to detection of a power loss on the first electrical interface, based on the current drawn over the first electrical interface at the time of the power loss. This means that the system remembers which current that was drawn when power at a work site was lost, e.g., due to that the electrical mains fuse was tripped. The current value is then indicative of the maximum allowable current to be drawn. Statistical measures of the current drawn just prior to the power loss can also be used, which then also accounts for variation in the load on electrical mains at a given site. The maximum current setting of the electrically configurable fuse can be updated in a convenient manner, either automatically based on a current drawn prior to power outage, or manually by an operator. The maximum current of the electrically configurable fuse can also be set based on data related to power capability of a work site received from a remote server or the like.

The motor drive system optionally comprises an electrical energy storage device connected, e.g., to a DC-bus of the frequency converter via a switch or connected to the drive system in some other way via the switch. The control unit may then control the switch in dependence of the current drawn over the first electrical interface and the maximum current setting of the electrically configurable fuse. The electrical energy storage then cuts any transient power peaks drawn by the system, which reduces the risk of tripping the electrically configurable fuse and/or the electrical mains fuse. It is an advantage that the electrical energy storage device control, i.e., the switching in and out of the energy storage device, is performed in dependence of the maximum current setting of the electrically configurable fuse. If the operator changes the maximum current setting of the electrically configurable fuse, then the control of the electrical energy storage device can be automatically updated such that it is switched in more often or less often depending on the new setting of the maximum current setting of the electrically configurable fuse. The electrical energy storage device thus supports the motor drive system with electrical power at an amount automatically determined based on the maximum current setting of the electrically configurable fuse. If the electrically configurable fuse is set at a low maximum current, then the electrical energy storage device is switched in more often compared to if the electrically configurable fuse is set at a higher maximum current.

According to some aspects, the system also comprises the frequency converter and associated control unit discussed above. This frequency converter is arranged to draw electrical power from electrical mains over the first electrical interface at a first frequency and to convert the first frequency into a second frequency for output on the second electrical interface to the electric machine. The control unit is arranged to control the frequency converter to generate the second frequency in dependence of a configurable maximum current to be drawn by the frequency converter over the first electrical interface. This maximum current setting of the frequency converter may be the same current setting that is used for the electrically configurable fuse or a different one. The current setting of the electrically configurable fuse is preferably the same or a bit higher than the current setting of the frequency converter. This way a maximum allowable current and/or power consumption of the motor drive system can be configured, and the motor drive system will then not draw more than the allowed amount of current. If it does so anyway due to, e.g., transient effects which can be hard to predict and to control, such as high unpredictable starting currents of the electric machine, then the electrically configurable fuse will trip, thus providing a back-up protection system that protects the electrical mains fuse. This means that the system can be configured to operate also at sites where electrical mains fusing is below the nominal power requirement of the construction equipment. The electrically configurable fuse acts as a back-up or safety system which will disconnect the construction equipment from electrical mains in case the operations by the frequency converter fail to limit drawn current to currents below the allowed amount of current. The frequency converter is, however, entirely optional, since the electrically configurable fuse can be used on its own without the frequency converter. Other mechanisms of controlling power consumption by construction equipment are known in the art, such as that in EP2842213 A1 and that in SE536147 C2.

There is also disclosed herein a motor drive system that comprises a control unit arranged to measure a magnitude of an electric current drawn over the first electrical interface, e.g., a current value in Ampere or a power value in Watts. The control unit is arranged to monitor the magnitude of the electric current, and to detect a power loss at the first electrical interface. The control unit is also arranged to, in response to detecting power loss at the first electrical interface, store a magnitude value of the electrical current drawn over the first electrical interface prior to detecting the power loss in a memory device. This way the system is able to detect which currents that are possible to draw from electrical mains at a given site, since each power loss event will be associated with a recorded magnitude value of a current that was drawn in connection to the power loss event, i.e., just prior to the power loss event. The one or more stored magnitude values of electrical current are indicative of the power rating of the electrical mains at a given work site. The control unit may, for instance, trigger display of the stored magnitude value on a display device or the like for communicating information to an operator, or automatically configure a maximum current that can be drawn over the electrical interface by the motor drive system based on the stored magnitude value of the electrical current.

It is appreciated that this function can be used independently of the frequency converters and the electrically configurable fuses discussed above. However, the maximum current drawn over the first interface can of course be limited by means of a frequency converter, and the frequency converter can then advantageously be configured in terms of the maximum allowable current it can draw based on the stored current magnitude values. The construction equipment may also comprise the electrically configurable fuse which can be set to trip before the electrical mains fuse, and it can also be configured with advantage based on the stored current magnitude values. Thus, the current monitoring techniques discussed herein are advantageously used as is or together with configurable power frequency converters and/or with electrically configurable fuses, since the techniques can be used to provide relevant work site specific input data to the configuration of the devices.

The motor drive system optionally comprises an electrical energy storage device connected to the motor drive system via, e.g., a DC-bus or in some other way via a switch. The control unit may then control the switch to connect and disconnect the energy storage to and from the motor drive system in dependence of the current drawn over the first electrical interface and the stored current value or values associated with one or more power loss events. The electrical energy storage then cuts any transient power peaks drawn by the system to be below the stored values where power loss occurred, which reduces the risk of tripping a fuse on the electrical mains. The combination of the electrical energy storage that can be switched in to cut a power peak and the control unit which monitors the currents at which power loss occurred is particularly advantageous since the electrical energy storage can “learn” at what current consumptions it should be switched in to minimize the occurrence of power loss. The hybrid motor drive system can thus be used at work sites where the power rating of the electrical mains is unknown, since the machine will learn what current magnitudes that can be supported at the work site. The control of the electrical energy storage device can also be based on statistics of the stored electrical current magnitude values, e.g., such that a likelihood of tripping the fuse on electrical mains is kept below a certain value.

The motor drive system optionally comprises a frequency converter in addition to the control unit. This frequency converter can be arranged to draw electrical power from electrical mains over the first electrical interface at a first AC frequency and to convert the first frequency into a second AC frequency for output on a second electrical interface to the electric machine. The control unit is arranged to control the frequency converter to generate the second frequency in dependence of a configurable maximum current to be drawn over the first electrical interface, e.g., the current detected by the control unit prior to power loss or a bit below. This way a maximum allowable current and/or power consumption of the motor drive system can be configured which is tailored to the electrical mains at the current work site, and the motor drive system will then not draw more than the allowed amount of current. This means that the system can be configured to operate also at sites where electrical mains fusing is below the nominal power requirement of the construction equipment. The combination of current monitoring by the control unit and power consumption control by the frequency converter is advantageous since the frequency converter can be controlled to limit power consumption even if the power rating of the electrical mains at a given work site is unknown.

According to aspects, the control unit is arranged to control the output of the frequency converter on the second electrical interface based on a target electric machine axle torque and/or based on a target electric machine axle speed determined in dependence of the configurable maximum current to be drawn over the first electrical interface. This way a predetermined relationship between electric machine axle torque and/or electric machine axle speed can be used to ensure that the current drawn over the first electrical interface does not exceed the configured maximum current to be drawn over the first electrical interface. Again, the configured maximum current to be drawn by the frequency converter is advantageously configured based on the current values stored by the control unit in connection to one or more power loss events. The configured maximum current to be drawn by the frequency converter can also be configured based on statistical measures of the current values stored by the control unit in connection to one or more power loss events, e.g., such that the likelihood of tripping the fuse of the electrical mains is kept below a certain value.

The motor drive system also, as noted above, advantageously comprises an electrically configurable fuse arranged in between a power input port to the frequency converter and the first electrical interface. This electrically configurable fuse protects the fuse on electrical mains, and it is often more easily reset compared to the fuser on electrical mains, which may be hard to access. The electrically configurable fuse can, e.g., be configured to disconnect the power input port to the frequency converter from the first electrical interface in response to a current drawn over the first electrical interface exceeding the configurable maximum current setting of the electrically configurable fuse. The maximum current setting of the electrically configurable fuse is advantageously set based on the measured current prior to power loss at the first electrical interface.

There are also disclosed herein construction machines, actuator control units, controllers, processing circuits, computer programs, computer program products as well as methods associated with the advantages mentioned above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 shows example construction equipment;

FIG. 2 shows an example remote-control device;

FIG. 3 schematically illustrates a motor drive system;

FIG. 4 shows a configurable fuse arranged in a motor drive system;

FIG. 5 is a flow chart; and

FIG. 6 schematically illustrates a control unit.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

The present disclosure relates to controlling one or more actuators on a construction machine, such as a percussion hammer or breaker, boom and stick motion of a tool carrier arm, body swing, and/or caterpillar tracks or drive wheel motion. It is appreciated that the control arrangements and methods disclosed herein can be used with advantage in demolition robots, and in particular in electrically powered remote-controlled demolition robots. However, many of the techniques discussed herein are also applicable in other types of construction machines, such as excavators and the like.

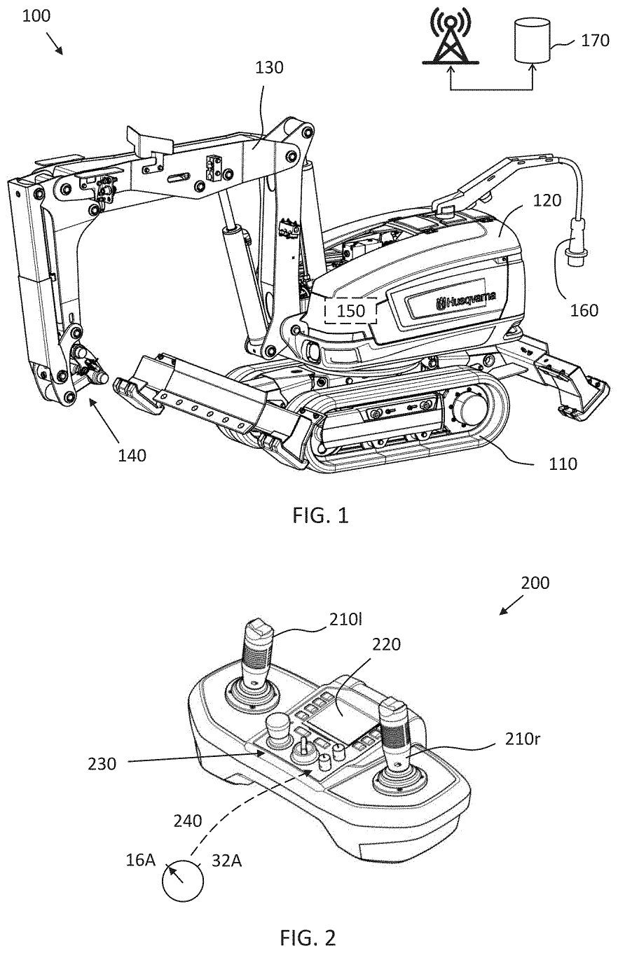

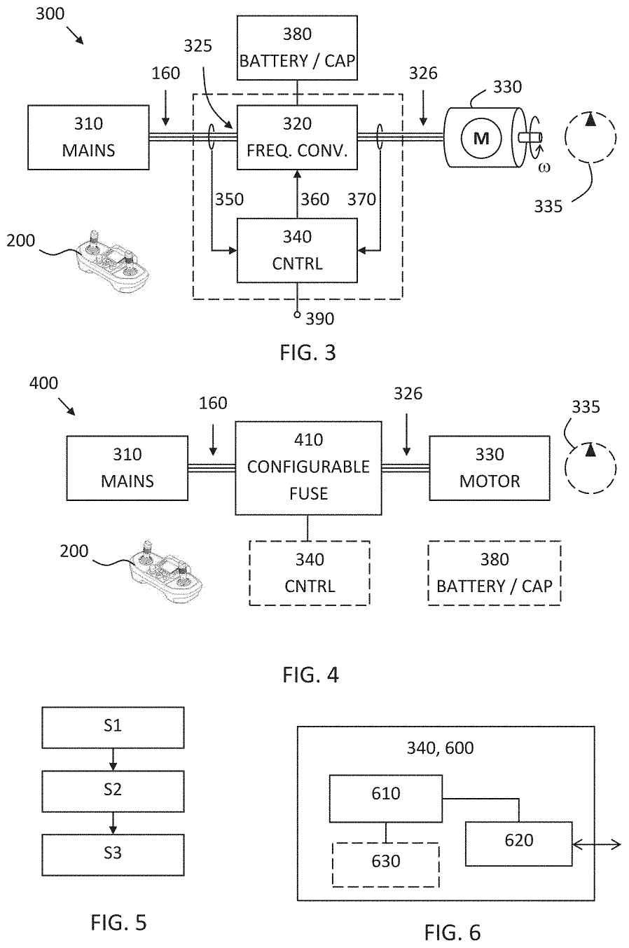

FIG. 1 illustrates a remote-controlled demolition robot, which is an example of a construction machine 100, i.e., a piece of construction equipment. The demolition robot comprises tracks 110 for propelling the robot over ground. It is appreciated that some construction machines may be supported on wheels instead of tracks. A body 120 is rotatably mounted on the bottom section of the machine which comprises the tracks. An arm 130, sometimes referred to as tool carrier, extends from the body 120. Various work tools, such as pneumatic or hydraulic hammers and the like can be carried on the distal end 140 of the arm. The various actuators on the construction machine 100 are powered by a hydraulic system 150, which is only schematically illustrated in FIG. 1. This hydraulic system 150 comprises an electric machine used to provide hydraulic flow by means of a hydraulic pump 335. The electric machine is controlled by a motor drive system which is the focus of the present application. This motor drive system will be discussed in detail below in connection to FIG. 3 and FIG. 4.

The construction machine 100 receives at least part of its operating power from the electrical mains connection 160, which often is a three-phase electrical interface. It is appreciated that a machine like a demolition robot normally requires quite high power for operating the above-mentioned actuators. The peak current drawn over the electrical interface 160 may be quite large, at least during transients. A main fuse of 32 Amperes (A) or even 64 A may be desired to provide the necessary power required to operate all functions of the machine at the highest level of performance.

The construction machine 100 may be arranged for autonomous operation, i.e., to operate without manual instructions from an operator, or it can be remote-controlled by an operator using different types of control input devices such as, e.g., levers, joysticks, touch screens or even haptic gloves and the like.

A remote server 170 may provide software upgrades and configuration data over wireless link to the machine 100. This remote server may, e.g., comprise stored data related to a capability of an electrical power grid at a construction site. The machine 100 can, according to some aspects, query the remote server 170 and receive information about the capabilities of the power grid at a given location. This information can then be used to configure one or more functions of the machine 100, such as a maximum current that can be drawn over the electrical interface 160.

FIG. 2 illustrates an example control device 200 in the form of a wireless remote-control. The control device 200 comprises left and right joysticks 2101, 210r, a display 220 for communicating information to an operator, and a plurality of buttons and levers 230 for controlling various functions on the construction machine 100. The control device 200 also comprises means 240 for selecting an operating mode of the construction machine 100, such as a first mode of operation and a second mode of operation. The first mode of operation may be associated with a reduced peak current over the electrical interface 160 compared to the second mode of operation. More than two modes of operation may be configurable. The mode of operation may also be configured on a continuous scale, i.e., not in discrete steps. For instance, a user may be able to configure a maximum current that can be drawn over the electrical interface 160 by inputting a value via the control device 200.

The remote-control device 200 is configured to communicate with the construction machine 100 via wireless radio link, such as a Bluetooth link, a wireless local area network (WLAN) radio link, or a cellular connection link, such as the cellular access network links defined by the third generation partnership program (3GPP), i.e., 4G, 5G and so on. The remote-control device 200 may also be arranged to communicate with the remote server 170.

It is proposed herein to use a frequency converter with a power limiting feature that enables the frequency converter to limit the power drawn over the electrical interface 160 towards mains in dependence of a maximum current setting. This maximum current setting can, for instance, be set from the remote-control, as shown in FIG. 2, or from input means arranged directly on the machine 100. The remote server 170 can also provide data to configure the allowable current to be drawn from electrical mains, for instance in dependence of construction site location, machine geographical position, electrical plans of the construction site, or the like.

FIG. 3 shows a motor drive system 300 for controlling an operation of an electric machine 330 on construction equipment 100, such as a demolition robot or the like. The system comprises a frequency converter 320 and a control unit 340. It is appreciated that the frequency converter and the control unit are often integrated into a single unit, i.e., the control unit 340 may form an integral part of the frequency converter 320, but it can also be physically separated from the frequency converter device 320. Frequency converters and their use in driving electric machines are generally known and will therefore not be discussed in more detail herein.

The frequency converter 320 is arranged to draw electrical power from electrical mains 310 over a first electrical interface 160 at a first non-zero AC frequency and to convert the first AC frequency into a second non-zero AC frequency for output on a second electrical interface 326 to the electric machine 330.

A frequency converter, also known as a frequency changer, is an electronic or electromechanical device that converts alternating current (AC) of one frequency to alternating current of another frequency. The device may also change the voltage, but if it does, that is incidental to its principal purpose. A variable-frequency drive (VFD) is a type of frequency changer used for speed control of AC motors such as used for pumps and fans. The speed of an AC motor is dependent on the frequency of the AC power supply, so changing frequency allows the motor speed and/or applied axle torque to be changed. A cycloconverter is also a type of frequency changer. Unlike a VFD, which is an indirect frequency changer since it uses an AC-DC stage and then a DC-AC stage, a cycloconverter is a direct frequency changer because it uses no intermediate stages. The frequency converters discussed herein can be of any type suitable for use in driving an electric machine.

The control unit 340, which may be an integral part of the frequency converter module or arranged separate from the actual frequency converter 320, is arranged to control 360 the frequency converter 320 to generate the second AC frequency in dependence of a configurable maximum current to be drawn over the first electrical interface 160. Thus, the control unit 340 configures a cap on the current consumption by the frequency converter 320, meaning that the machine can be used also at construction sites where the mains electricity has a power limitation below the nominal power requirements of the machine 100.

The maximum allowed current consumption can be configured via an input port 390, e.g., from the remote-control 200. The construction equipment 100 will then be able to operate also at construction sites lacking a high power electrical mains, at reduced performance.

The control unit 340 can control the operation of the frequency converter 320 to limit the current drawn by it from electrical mains over the first electrical interface 160 in several different ways.

According to an example, the control unit 340 measures 350 the current drawn over the first electrical interface 160. The control unit then generates the second AC frequency in dependence of the configurable maximum current to be drawn over the first electrical interface 160 such that the measured current 350 never exceeds the configurable maximum current, which can be done by application of adaptive algorithms and/or by using look-up tables of predetermined set-points of converter operation. In other words, the control unit 340 may be arranged to obtain a measurement 350 of current drawn over the first electrical interface 160 and to control the output on the second electrical interface 326 based on the measurement of current and on the configurable maximum current to be drawn over the first electrical interface 160.

Generally, the power consumption of a hydraulic drive system comprising an electric machine depends on the amplitudes of the currents on the second electrical interface 326 to the electric machine 330 and on the frequency of the currents, i.e., the second AC frequency. The amplitude of the currents on the second electrical interface is related to the torque generated by the electric machine 330 while the second AC frequency is related to the speed of the electric machine drive shaft. If the hydraulic pump 335 is a fixed displacement pump, then the hydraulic flow is also possible to regulate by the pump itself, in which case the load on the electric machine changes in a known manner.

Additional advantages may be obtained if the hydraulic pump 335 is an electro proportional pump. An electro-proportional pump is a variable displacement pump which can be controlled using electrical signals from a control unit such as the control unit 340. By configuring the displacement of the electro-proportional pump from the control unit 340, additional degrees of freedom can be exploited in the optimization of the hydraulic drive system. The electro-proportional pump can, for instance, be used to regulate hydraulic flow and/or hydraulic pressure for a given second AC frequency (and/or amplitude) on the second electrical interface.

According to some aspects, the frequency converter 320 is furthermore arranged to control an amplitude of the currents output on the second electrical interface 326 to the electric machine 330. The control unit controls the frequency converter 320 to also generate the amplitude in dependence of the configurable maximum current to be drawn over the first electrical interface 160.

The power factor of an AC power system is defined as the ratio of the real power absorbed by the load to the apparent power flowing in the circuit and is a dimensionless number in the closed interval of −1 to 1. A power factor magnitude of less than one indicates the voltage and current are not in phase, reducing the average product of the two, which is almost always the case for the type of drive systems discussed herein. Real power is the instantaneous product of voltage and current and represents the capacity of the electricity for performing work. Apparent power is the product of root-mean-square (RMS) current and voltage. Due to energy stored in the load and returned to the source, or due to a non-linear load that distorts the wave shape of the current drawn from the source, the apparent power may be greater than the real power. This apparent power is what may trigger a fuse on electrical mains. In an electric power system, a load with a low power factor draws more current than a load with a high power factor for the same amount of useful power transferred. The higher currents increase the energy lost in the distribution system and require larger wires and higher capacity fuses.

According to some aspects, the frequency converter 320 comprises a power factor correction circuit. This power factor correction circuit increases the power factor of the system and therefore alleviates the problems associated with apparent power. It may, e.g., be realized using a passive network of capacitors and/or inductors.

The control unit 340 can also measure the output currents on the second electrical interface 326 to the electric machine 330, and from this information determine an axle torque that is generated by the electric machine 330 and also an axle speed of the electric machine 330. Methods for determining both axle torque and axle speed from motor currents are known and will therefore not be discussed in more detail herein. By setting a limit on allowable applied axle torque and/or speed, the current drawn over the first electrical interface can also be limited. A pre-configured look-up table can be used to obtain the relationship between applied axle torque and/or axle speed and current drawn over the first electrical interface 160. In other words, the control unit 340 may be arranged to control the output on the second electrical interface 326 based on a target electric machine axle torque and/or based on a target electric machine axle speed determined in dependence of the configurable maximum current to be drawn over the first electrical interface 160.

The control unit 340 may furthermore be arranged to predict a future current drawn over the first electrical interface 160 based on a time sequence of obtained measurements of current 350 drawn over the first electrical interface 160, and to control the output on the second electrical interface 326 based on the predicted future current drawn over the first electrical interface 160. Given a sequence of current measurements, it is possible to establish a trend and to extrapolate the data into an estimated future current consumption of the machine. A Kalman filter can for instance be used to perform this extrapolation, although a simple linear fit to the time sequence of current measurements is most likely sufficient. This type of prediction of future drawn currents may at least in part compensate for delays in the switching and reconfiguration of the motor drive system, thereby avoiding that transients occur which surpass the configurable maximum current to be drawn over the first electrical interface 160.

It is appreciated that particularly high currents may be drawn over the first electrical interface 160 during acceleration of the electric machine 330, e.g., as the machine 330 is started from stand-still. The control unit 340 is optionally arranged to limit an acceleration of the electric machine 330 in dependence of the configurable maximum current to be drawn over the first electrical interface 160, i.e., to not allow a too fast increase in motor axle speed, which could otherwise risk breaching the maximum allowable current to be drawn over the first electrical interface.

The maximum current to be drawn over the first electrical interface 160 is optionally arranged to be set by a user control input device 240, e.g., as illustrated in FIG. 2 by a control knob or display option in a remote-control 200. This type of manual control allows an operator to configure the maximum current that can be drawn by the machine over the first electrical interface 160 based on information obtained by the operator regarding the electrical mains at a construction site. However, the maximum current to be drawn over the first electrical interface 160 can also be automatically configured. For instance, the maximum current to be drawn over the first electrical interface 160 can be set in response to detection of a power loss on the first electrical interface 160 due to a likely tripped fuse on electrical mains, and based on the current drawn over the first electrical interface 160 at the time of the power loss, i.e., the current drawn over the first electrical interface just prior to the power loss is remembered, and later used to adjust the maximum current setting. Thus, the control unit 340 may continuously monitor the current drawn over the first electrical interface, and if there is a power loss the current value at the time of the power loss can be stored in memory. By setting the maximum current to be drawn over the first electrical interface 160 based on this measured current, the setting can be adjusted to the operating conditions at the work site. Alternatively, the current drawn over the first electrical interface 160 at the time of the power loss can be communicated to a user via some form of display, informing the user about the current consumption at the time of the power loss.

This current monitoring feature can be realized independently of the frequency converter and independently from the electrically configurable fuse discussed herein. Thus, there is disclosed herein a motor drive system 300, 400 for controlling an operation of an electric machine 330 on construction equipment 100, where the motor drive system 300, 400 is arranged to draw an electric current from electrical mains 310 over a first electrical interface 160. The system comprises a control unit 340 (which can be the same control unit used to control the frequency converter or a different one) arranged to measure 350 a magnitude of an electric current drawn over the first electrical interface 160. The control unit 340 is arranged to monitor the magnitude of the electric current, and to detect a power loss at the first electrical interface 160. The control unit 340 is also arranged to store a magnitude value of the electrical current drawn over the first electrical interface prior to detecting the power loss in a memory device 630, in response to detecting power loss at the first electrical interface 160. The control unit may also control one or more functions of the motor drive system 300, 400 and/or of the construction equipment 100 based on the stored magnitude value of the electrical current.

The control unit 340 may store more than one current magnitude value associated with more than one respective power loss events. This allows the control unit 340 to determine statistical measures such as mean and variance of the stored current magnitude values at which power was lost. A statistical distribution, such as a normal distribution, can then be fit to the stored current magnitude values and used to determine likelihoods of power outage for a given maximum current consumption. For instance, suppose that a normal distribution of a given mean and variance has been fit to stored current magnitude values. It is then possible using known statistical methods to find a current value for a given likelihood of power outage.

The motor drive system 300 may also comprise an electrical energy storage device 380, such as a battery or a super-capacitor, connected to a DC-bus of the frequency converter 320 via a transistor switch or the like. The control unit 340 may then control the switch in dependence of the current drawn over the first electrical interface 160 and the configurable maximum current to be drawn over the first electrical interface 160 and/or in dependence of the current magnitude values stored by the control unit. This way the electrical energy storage device 380 can be used to cut high current peaks in an efficient manner. The electrical energy storage device 380 can then be recharged to prepare for the next current peak. Thus, the electrical energy storage device 380 can be used to avoid power loss, even if the power rating of the electrical mains at a given work site is unknown. The switch may, e.g., be controlled so as to connect the electrical energy storage device 380 to the motor drive system if the current drawn by the motor drive system approaches the stored current value. When the electrical energy storage device 380 is switched in, current is also drawn from the electrical energy storage device, which reduces the current drawn from electrical mains.

The motor drive system 400 optionally comprises an electrically configurable fuse 410 arranged in between a power input port 325 to the frequency converter 320 and the first electrical interface 160, as illustrated in FIG. 4. An electrically configurable fuse 410, also known as an eFuse, is essentially a transistor based switch which disconnects its two input ports from each other if a current measured between the input ports exceeds some configurable value. The electrically configurable fuse 410 can be configured to disconnect the power input port 325 to the frequency converter 320 from the first electrical interface 160 in response to a current drawn over the first electrical interface 160 exceeding the configurable maximum current to be drawn over the first electrical interface 160. The switch is different from a melting fuse or manually controlled automatic fuse in the sense that it can be reset electrically by a control signal, and often does not need manual reset. It may be convenient for the operator to be able to control the electrically configurable fuse 410, e.g., from a user control input device, such as the remote-control 200.

FIG. 4 shows a control unit 340. It is appreciated that the control unit 340 can be the same as the one used to control the optional frequency converter 320, or another control unit which is independent of the frequency converter, i.e., a control unit 340 which may be present even if no frequency converter is realized.

The electrically configurable fuse 410 can also be used with advantage in a stand-alone manner, e.g., together with the system discussed in SE536147 C2. For instance, a motor drive system 400 for controlling an operation of an electric machine 330 on construction equipment 100 can be designed using this type of fuse which does not trigger the main fuse on a construction site even if the current exceeds the maximum permitted level, since the electrically configurable fuse will trigger instead. The system comprises a first electrical interface 160 arranged to be connected to electrical mains 160 and a second electrical interface 430 arranged to be connected to the electric machine 330, the drive system further comprising an electrically configurable fuse 410 arranged in between the first electrical interface 160 and the second electrical interface 326, where the electrically configurable fuse 410 is configured to disconnect the first electrical interface 160 from the second electrical interface 430 in response to a current drawn over the first electrical interface 160 exceeding a configurable maximum current to be drawn over the first electrical interface 160.

The maximum current setting of the electrically configurable fuse is optionally arranged to be set by a user control input device 240, e.g., as illustrated in FIG. 2 by a control knob or display option in a remote-control 200. This type of manual control allows an operator to configure the maximum current that can be drawn by the machine over the first electrical interface 160 based on information obtained by the operator regarding the electrical mains at a construction site. However, the maximum current setting of the electrically configurable fuse can also be automatically configured. For instance, the maximum current to be drawn over the first electrical interface 160 can be set in response to detection of a power loss on the first electrical interface 160 due to a likely tripped fuse on electrical mains, and based on the current drawn over the first electrical interface 160 at the time of the power loss, i.e., the current drawn over the first electrical interface just prior to the power loss is remembered, and later used to adjust the maximum current setting. Thus, the control unit 340 may continuously monitor the current drawn over the first electrical interface, and if there is a power loss the current value at the time of the power loss can be stored in memory. By setting the maximum current to be drawn over the first electrical interface 160 based on this measured current, the setting can be adjusted to the operating conditions at the work site. Alternatively, the current drawn over the first electrical interface 160 at the time of the power loss can be communicated to a user via some form of display, informing the user about the current consumption at the time of the power loss.

The motor drive system 300 may also comprise an electrical energy storage device 380, such as a battery or a super-capacitor, connected to a DC-bus of the frequency converter 320 via a transistor switch or the like. The control unit 340 or some other control unit independent from the frequency converter may then control the switch in dependence of the current drawn over the first electrical interface 160 and the configurable maximum current to be drawn over the first electrical interface 160. This way the electrical energy storage device 380 can be used to cut high current peaks in an efficient manner. The electrical energy storage device 380 can then be recharged to prepare for the next current peak. Further advantages are obtained if the control of the electrical energy storage device 380 by the control unit 340 is made in dependence of the maximum current setting of the electrically configurable fuse. In this case the electrical energy storage device is switched in and out to control the current drawn over the first electrical interface 160 in dependence of the maximum current setting of the electrically configurable fuse, such that the current drawn over the first electrical interface 160 is kept below the maximum current setting of the electrically configurable fuse.

FIG. 5 is a flow chart illustrating a method which summarizes the above discussions. There is illustrated a method for controlling an operation of an electric machine 330 on construction equipment 100 by a motor drive system 300, 400 comprising a frequency converter 320 and a control unit 340. The method comprises receiving S1 electrical power by the frequency converter 320 from electrical mains 310 over a first electrical interface 160 at a first AC frequency, converting S2 the first AC frequency into a second AC frequency for output on a second electrical interface 326 to the electric machine 330, and controlling S3 the frequency converter 320 by the control unit 340 to generate the second AC frequency in dependence of a configurable maximum current to be drawn over the first electrical interface 160.

FIG. 5 also illustrates a method for controlling an operation of an electric machine 330 on construction equipment 100. The method comprising connecting S1 a first electrical interface 160 to electrical mains 310 and a second electrical interface 326 at least indirectly to the electric machine 330, arranging S2 an electrically configurable fuse 410 in between the first electrical interface 160 and the second electrical interface 326, and configuring S3 a maximum current setting of the electrically configurable fuse, where the electrically configurable fuse 410 is configured to disconnect the first electrical interface 160 from the second electrical interface 326 in response to a current drawn over the first electrical interface 160 exceeding the maximum current setting of the electrically configurable fuse.

FIG. 5 furthermore illustrates a method for controlling an operation of an electric machine 330 on construction equipment 100, where a motor drive system 300, 400 is arranged to draw an electric current from electrical mains 310 over a first electrical interface 160, the method comprising:

measuring S1, by a control unit 340, a magnitude of an electric current drawn over the first electrical interface 160, monitoring S2, by the control unit 340, the magnitude of the electric current, and detecting a power loss at the first electrical interface 160, and in response to detecting power loss at the first electrical interface 160, storing S3 a magnitude value of the electrical current drawn over the first electrical interface prior to detecting the power loss in a memory device 630.

FIG. 6 schematically illustrates, in terms of a number of functional units, the general components of a control unit 600, such as the control unit 340 discussed above. This control unit can be used to implement, e.g., parts of the control functionality of the motor drive system 300, 400. Processing circuitry 610 is provided using any combination of one or more of a suitable central processing unit CPU, multiprocessor, microcontroller, digital signal processor DSP, etc., capable of executing software instructions stored in a computer program product, e.g. in the form of a storage medium 630. The processing circuitry 610 may further be provided as at least one application specific integrated circuit ASIC, or field programmable gate array FPGA.

Particularly, the processing circuitry 610 is configured to cause the device 600 to perform a set of operations, or steps, such as the methods discussed in connection to FIG. 5 and the discussions above. For example, the storage medium 630 may store the set of operations, and the processing circuitry 610 may be configured to retrieve the set of operations from the storage medium 630 to cause the device to perform the set of operations. The set of operations may be provided as a set of executable instructions. Thus, the processing circuitry 610 is thereby arranged to execute methods as herein disclosed.

The storage medium 630 may also comprise persistent storage, which, for example, can be any single one or combination of magnetic memory, optical memory, solid state memory or even remotely mounted memory.

The device 340, 600 may further comprise an interface 620 for communications with at least one external device. As such the interface 620 may comprise one or more transmitters and receivers, comprising analogue and digital components and a suitable number of ports for wireline or wireless communication.

The processing circuitry 610 controls the general operation of the control unit 340, 600, e.g., by sending data and control signals to the interface 620 and the storage medium 630, by receiving data and reports from the interface 620, and by retrieving data and instructions from the storage medium 630.

### List of Example Implementations Related to the Electrically Configurable Fuse

The below list of examples relates to the electrically configurable fuse when used in a stand-alone manner with or without the frequency converter and/or the current monitoring functions of the control unit.

Example 1. A motor drive system 400 for controlling an operation of an electric machine 330 on construction equipment 100, the system comprising a first electrical interface 160 arranged to be connected to electrical mains 310 and a second electrical interface 326 arranged to be connected at least indirectly to the electric machine 330, the drive system 400 further comprising an electrically configurable fuse 410 arranged in between the first electrical interface 160 and the second electrical interface 326, where the electrically configurable fuse 410 is configured to disconnect the first electrical interface 160 from the second electrical interface 326 in response to a current drawn over the first electrical interface 160 exceeding a configurable maximum current of the electrically configurable fuse 410.

Example 2. The motor drive system 300, 400 according to example 1 in this list, further comprising a frequency converter 320 and a control unit 340,

where the frequency converter 320 is arranged to draw electrical power from electrical mains 310 over the first electrical interface 160 at a first frequency and to convert the first frequency into a second frequency for output on the second electrical interface 326 to the electric machine 330,

where the control unit 340 is arranged to control 360 the frequency converter 320 to generate the second frequency in dependence of a configurable maximum current of the frequency converter to be drawn over the first electrical interface 160.

Example 3. The motor drive system 300, 400 according to example 2 in this list, where the electrically configurable fuse 410 is configured to disconnect the power input port 325 to the frequency converter 320 from the first electrical interface 160 in response to a current drawn over the first electrical interface 160 exceeding the configurable maximum current of the electrically configurable fuse.

Example 4. The motor drive system 400 according to any previous example in this list, where the maximum current of the electrically configurable fuse 410 is arranged to be configured from a user control input device 200.

Example 5. The motor drive system 300, 400 according to any previous example in this list, wherein the maximum current of the electrically configurable fuse 410 is arranged to be set by a user control input device 240.

Example 6. The motor drive system 300, 400 according to any previous example in this list, wherein the maximum current of the electrically configurable fuse 410 is arranged to be set based on data related to power capability of a work site received from a remote server 170.

Example 7. The motor drive system 300, 400 according to any previous example in this list, wherein the configurable maximum current of the electrically configurable fuse is arranged to be set in response to detection of a power loss on the first electrical interface 160 and based on the current drawn over the first electrical interface 160 at the time of the power loss.

Example 8. The motor drive system 300 according to any previous example in this list, comprising an electrical energy storage device 380 connected to the system 300, 400 via a switch, wherein the control unit 340 is arranged to control the switch in dependence of the current drawn over the first electrical interface 160 and the configurable maximum current of the electrically configurable fuse 410.

Example 9. A construction machine 100 comprising a motor drive system 300, 400 according to any previous example in this list.

### List of Example Implementations Related to the Current Monitoring Function

The below list of example embodiments relates to the current monitoring functions discussed herein when used in a stand-alone manner with or without the frequency converter and/or the electrically configurable fuse.

Example 1. A motor drive system 300, 400 for controlling an operation of an electric machine 330 on construction equipment 100, where the motor drive system 300, 400 is arranged to draw an electric current from electrical mains 310 over a first electrical interface 160,

the system comprising a control unit 340 arranged to measure 350 a magnitude of an electric current drawn over the first electrical interface 160,

where the control unit 340 is arranged to monitor the magnitude of the electric current, and to detect a power loss at the first electrical interface 160,

where the control unit 340 is arranged to, in response to detecting power loss at the first electrical interface 160,

store a magnitude value of the electrical current drawn over the first electrical interface prior to detecting the power loss in a memory device 630.

Example 2. The motor drive system 300, 400 according to example 1 in this list, where the control unit 340 is arranged to trigger display of the stored magnitude value on a display 220 for communicating information to an operator.

Example 3. The motor drive system 300, 400 according to example 1 or 2 in this list, where the control unit 340 is arranged to configure a maximum current that can be drawn over the electrical interface 160 by the motor drive system 300, 400 based on the stored magnitude value of the electrical current.

Example 4. The motor drive system 300, 400 according to any previous example in this list, further comprising a frequency converter 320 and a control unit 340,

where the frequency converter 320 is arranged to draw electrical power from electrical mains 310 over the first electrical interface 160 at a first frequency and to convert the first frequency into a second frequency for output on a second electrical interface 326 to the electric machine 330,

where the control unit 340 is arranged to control 360 the frequency converter 320 to generate the second frequency in dependence of a configured maximum current to be drawn over the first electrical interface 160.

Example 5. The motor drive system 400 according to example 4 in this list, where the configured maximum current to be drawn over the first electrical interface 160 by the frequency converter 320 is arranged to be automatically set by the control unit 340 based on the stored magnitude value of the electrical current drawn over the first electrical interface prior to detecting the power loss.

Example 6. The motor drive system 400 according to any previous example in this list, where the first electrical interface 160 is at least indirectly connected to the electric machine 330 via a second electrical interface 326, the motor drive system 400 further comprising an electrically configurable fuse 410 arranged in between the first electrical interface 160 and the second electrical interface 326, where the electrically configurable fuse 410 is configured to disconnect the first electrical interface 160 from the second electrical interface 326 in response to a current drawn over the first electrical interface 160 exceeding a configurable maximum current setting of the of the electrically configurable fuse 410.

Example 7. The motor drive system 400 according to example 6 in this list, where the configurable maximum current setting of the of the electrically configurable fuse 410 is arranged to be automatically set by the control unit 340 based on the stored magnitude value of the electrical current drawn over the first electrical interface prior to detecting the power loss.

Example 8. The motor drive system 300, 400 according to any previous example in this list, comprising an electrical energy storage device 380 connected to the system 300, 400 via a switch, wherein the control unit 340 is arranged to control the switch in dependence of the current drawn over the first electrical interface 160 and the stored magnitude value of the electrical current drawn over the first electrical interface prior to detecting the power loss.

Example 9. A construction machine 100 comprising a motor drive system 300, 400 according to any previous example in this list.

1. A motor drive system for controlling an operation of an electric machine on construction equipment, the system comprising a frequency converter and a control unit,
where the frequency converter is arranged to draw electrical power from electrical mains over a first electrical interface at a first alternating current, AC, frequency and to convert the first AC frequency into a second AC frequency for output on a second electrical interface to the electric machine,
where the control unit is arranged to control the frequency converter to generate the second AC frequency in dependence of a configurable maximum current to be drawn over the first electrical interface.

2. The motor drive system according to claim 1, wherein the control unit is arranged to control the output on the second electrical interface based on a target electric machine axle torque and/or based on a target electric machine axle speed determined in dependence of the configurable maximum current to be drawn over the first electrical interface.

3. The motor drive system according to claim 1, wherein the control unit is arranged to obtain a measurement of current drawn over the first electrical interface and to control the output on the second electrical interface based on the measurement of current and on the configurable maximum current to be drawn over the first electrical interface.

4. The motor drive system according to claim 3, wherein the control unit is arranged to predict a future current drawn over the first electrical interface based on a time sequence of obtained measurements of current drawn over the first electrical interface, and to control the output on the second electrical interface based on the predicted future current drawn over the first electrical interface.

5. The motor drive system according to claim 1, wherein the control unit is arranged to limit an acceleration of the electric machine in dependence of the configurable maximum current to be drawn over the first electrical interface.

6. The motor drive system according to claim 1, wherein the configurable maximum current to be drawn over the first electrical interface is arranged to be set by a user control input device.

7. The motor drive system according to claim 1, wherein the configurable maximum current to be drawn over the first electrical interface is arranged to be set in response to detection of a power loss on the first electrical interface and based on a current drawn over the first electrical interface at the time of the power loss.

8. The motor drive system according to claim 1, comprising an electrically configurable fuse arranged in between a power input port to the frequency converter and the first electrical interface.

9. The motor drive system according to claim 8, wherein the electrically configurable fuse is configured to disconnect the power input port to the frequency converter from the first electrical interface in response to a current drawn over the first electrical interface exceeding the configurable maximum current to be drawn over the first electrical interface.

10. The motor drive system according to claim 8, wherein the electrically configurable fuse is arranged to be controlled from a user control input device.

11. The motor drive system according to claim 1, comprising an electrical energy storage device connected to a direct current, DC, bus of the frequency converter via a switch, wherein the control unit is arranged to control the switch in dependence of a current drawn over the first electrical interface and the configurable maximum current to be drawn over the first electrical interface.

12. The motor drive system according to claim 1, wherein the first electrical interface is a three-phase electrical interface.

13. The motor drive system according to claim 1, wherein the frequency converter is a variable-frequency drive, VFD, device or a cycloconverter.

14. The motor drive system according to claim 1, wherein the frequency converter is furthermore arranged to control an amplitude of currents output on the second electrical interface to the electric machine, wherein the control unit is arranged to control the frequency converter to generate the amplitude in dependence of the configurable maximum current to be drawn over the first electrical interface.

15. The motor drive system according to claim 1, where the frequency converter comprises a power factor correction circuit.

16. A construction machine comprising the motor drive system according to claim 1.

17. A method for controlling an operation of an electric machine on construction equipment by a motor drive system comprising a frequency converter and a control unit,
the method comprising
receiving electrical power by the frequency converter from electrical mains over a first electrical interface at a first AC frequency,
converting the first AC frequency into a second AC frequency for output on a second electrical interface to the electric machine, and
controlling the frequency converter by the control unit to generate the second AC frequency in dependence of a configurable maximum current to be drawn over the first electrical interface.

18. A motor drive system for controlling an operation of an electric machine on construction equipment, the system comprising a first electrical interface arranged to be connected to electrical mains and a second electrical interface arranged to be connected to the electric machine, the drive system further comprising an electrically configurable fuse arranged in between the first electrical interface and the second electrical interface, wherein the electrically configurable fuse is configured to disconnect the first electrical interface from the second electrical interface in response to a current drawn over the first electrical interface exceeding a configurable maximum current to be drawn over the first electrical interface.

19. A motor drive system for controlling an operation of an electric machine on construction equipment, wherein the motor drive system is arranged to draw an electric current from electrical mains over a first electrical interface,
the system comprising a control unit arranged to measure a magnitude of an electric current drawn over a first electrical interface,
where the control unit is arranged to monitor the magnitude of the electric current, and to detect a power loss at the first electrical interface,
where the control unit is arranged to, in response to detecting power loss at the first electrical interface,
store a magnitude value of the electrical current drawn over the first electrical interface prior to detecting the power loss in a memory device.

20. The motor drive system according to claim 19, wherein the control unit is arranged to trigger display of the stored magnitude value on a display for communicating information to an operator.

21. The motor drive system according to claim 19, wherein the control unit is arranged to configure a maximum current that can be drawn over the first electrical interface based on a stored magnitude value of the electrical current.
